(19) United States
(12) Patent Application Publication
(10) Pub. No.: US 2010/0003945 A1
(43) Pub. Date: Jan. 7, 2010

(54) Cellular emergency notification service

(75) Inventors: Avi Primo, Givataim (IL); Gil Amit, Yehud (IL)

Correspondence Address: THE NATH LAW GROUP, 112 South West Street, Alexandria, VA, 22314, US

(73) Assignee: CELLTICK TECHNOLOGIES LTD., Herzliya (IL)

(21) Appl. No.: 12/227,978

(22) PCT Filed: Jun. 11, 2007
(86) PCT No.: PCT/IL07/00701

§ 371 Date: Dec. 4, 2008

(30) Foreign Application Priority Data
Jun. 13, 2006 (IL) 176275

(51) Int. Cl. H04M 11/04

(52) U.S. Cl. 455/404.1

(57) ABSTRACT

Cellular emergency notification service transmitting Point-To-MultiPoint (P2MP) emergency service messages on one or more mandatory non-user configurable P2MP emergency channels to all available personal cellular telecommunications devices in one or more selected cells thereby ensuring mandatory reception.

### CROSS-REFERENCE TO RELATED APPLICATIONS

This application is the national phase of International Application Serial Number PCT/IL2007/000701 filed 11 Jun. 2007 designating the United States and published in English, the entire contents of which is incorporated herein in its entirety by reference.

### FIELD OF THE INVENTION

The invention pertains to cellular emergency notification services.

### BACKGROUND OF THE INVENTION

US Patent Application Publication No. US 2003/0141971 entitled Electronic Emergency Incident Notification System (“EEINS”) allows subscribers to transmit notification of a nuclear/chemical/biological release to a central server for transmittal to the appropriate governmental agencies. In the preferred embodiment, a subscriber would utilize a user interface device to transmit spatial data and an incident report to the central server, typically using the Internet. The central server would map the spatial data onto a GIS database to determine which agencies require notification, and would then transmit the incident report to the receiving nodes at the appropriate agencies. At the local level, the receiving node may include software to automatically activate the appropriate public warning systems. The EEINS is sufficiently flexible to service both fixed and mobile sites.

US Patent Application Publication No. US 2005/0261012 entitled Public Service Message Broadcasting System and Method illustrates and describes a public service message location broadcast system and method for broadcasting a message to communication receiving devices located within a defined geographic broadcast target area. The broadcast target area is defined by a broadcast agent using a broadcast agent webpage and a broadcast service bureau transmits the broadcast message to one or more local carriers who provide telecommunication service to the broadcast target area. The local carrier transmits the broadcast message to targeted users within the broadcast target area.

U.S. Pat. No. 7,039,386 to Kolsrud entitled Cellular Base Station Broadcast Method and System illustrates and describes a method and system for distributing emergency warning messages to users. In the method, an emergency broadcast station receives report of an impending or current disaster-related situation from a local authority. The geographic area to be affected by the impending or current disaster-related situation is served by an existing communication system, such as a cellular network. The emergency broadcast station generates a signal representing an emergency broadcast message that contains a frequency of an accessible main emergency channel at the emergency broadcast station, and a priority level classifying the emergent or impending disaster-related situation. The signal is transmitted to one or base stations, each serving a plurality of users of the system which in turn send the signal to the users. The users tune to the frequency of the channel to receive the emergency broadcast message.

Several bodies are actively working to promote cellular emergency notification services for broadcasting emergency service messages during natural disasters, terrorist incidents, and the like, to users located in affected cells. One such body is the Cellular Emergency Advisory Systems Association (CEASA) (see www.ceasa-int.org). Most mobile handsets are now capable of receiving cell broadcast messages, and accordingly have a mobile handset Man Machine Interface (MMI) for inter alia activating and de-activating particular cell broadcast channels or cell broadcast reception entirely. However, there is no specification specifying standard mobile handset behavior on receiving cell broadcast messages which is a major factor militating against cell broadcast services in general, and cellular emergency notification services in particular. For example, some mobile handsets immediately display cell broadcast messages whilst others store them for subsequent retrieval by a user. The Cell Broadcast Forum (CBF) is a non-profit Industry Association that supports a world standard for cell broadcast wireless information and telephony services on digital mobile phones and other wireless terminals (see www.cellbroadcastforum.org). In particular, CBF is actively working to standardize homogenous behavior on GSM mobile handsets on receiving incoming CB messages.

Celltick Technology Ltd., Herzliya, Israel, (see www.celltick.com) is a provider of a cellular mobile solution commercially available under the trade name Livescreen™ for delivering mobile content for silent unobtrusive display on mobile handsets in an idle state for enriching user experience in general, and interactive mobile content for encouraging consumption of mobile services including Value Added Services in particular. Celltick's Livescreen™ mobile solution is now being broadcast on GSM networks under different brand names including inter alia HutchAlive™ by Hutch, India; and Chameleon by Vimplecom Russia. Network operators typically broadcast Livescreen™ display messages in the native languages of their respective countries. Users who have selected a different non-native operating language from a list of mobile handset supported operating languages for their personal telecommunications devices have the option of either receiving and displaying the native language Livescreen™ display messages or deactivating their Livescreen™ service. For example, an English speaking user residing in Russia and who doesn't know Russian will in all likelihood deactivate a Russian language Livescreen™ service. Some network operators have employed their Celltick's Livescreen™ implementations as a cellular emergency notification service in a number of recent emergency situations. Celltick's website includes on-line press releases regarding such opportune use in the time of need:

1) Celltick's Mobile Interactive Broadcast to the Rescue in Mumbai Terror Attack online at http://www.celltick.com/showpr.asp?id=800&pr=43 on May 20, 2006
2) Celltick's LiveScreen operated as mobile emergency alert system during Tsunami crisis in Sri Lanka online at http://www.celltick.com/showpr.asp?id=800&pr=47 on May 20, 2006.

### SUMMARY OF THE INVENTION

The present invention is directed toward a Cellular Emergency Notification Service (CENS) transmitting Point-To-MultiPoint (P2MP) emergency service messages on P2MP emergency channels to all powered up personal cellular telecommunications devices in one or more affected cells selected by a civil or military body authorized to operate the CENS. The P2MP emergency channels are intentionally selected to be non-user configurable such that reception of the service is mandatory in all cells in which the service is activated without requiring user initiation and without users being able to deliberately or accidentally switch off the service. The P2MP emergency channels are envisaged to be largely idle insofar that they only bear P2MP emergency service messages regarding incidents which merit same, for example, natural disasters, terrorist alerts, and the like. P2MP emergency service messages are preferably highly intrusive for automatic immediate rendering on personal cellular telecommunication devices in a uniform manner irrespective of vendor, model number, and the like. Such automatic immediate rendering involves the immediate automatic overriding of any ongoing user and/or network activity including inter alia interrupting a telephone call, sending a message, rendering stored content, and the like. Rendering is in the form of at least one and preferably all of displaying text messages, issuing audible alerts, issuing vibratory alerts, and the like. Audible alerts are preferably highly distinctive from reception tones employed for point-to-point SMS for gaining users' immediate attention. Suitable audible alerts can be in the form of a continuous siren, a wailing siren, and the like.

The present invention can be implemented using different Point-To-MultiPoint (P2MP) broadcast technologies for broadcasting the same P2MP emergency message to all available personal cellular telecommunications devices in one or more cells. P2MP pushing of a single message simultaneously to all available devices in a single cell is a standard feature of several cellular technologies having different terms for the same technological capability. For example, Cell broadcast as defined by official standardization bodies such as GSM and 3GPP as well as its equivalent Broadcast SMS defined in 3GPP2 and IS95CDMA. Also, Multimedia Broadcast and Multi-cast Service (MBMS/BCMCS) as defined by the 3GPP/3GPP2 official standardization body, DVB-H (Digital Video Broadcast—Handheld), DMB (Digital Media Broadcast) MediaFLO, and others. In some P2MP broadcast technologies, P2MP emergency service messages are broadcast on dedicated physical P2MP transmission channels. In other P2MP broadcast technologies, P2MP emergency service messages are transmitted on the same physical P2MP transmission channel as other P2MP non-emergency service messages but have a unique channel identifier forming part of their message headers for distinguishing them from other P2MP non-emergency service messages. For the purpose of the present invention, the coined term “logical P2MP transmission channel” is intended to encompass both implementations for bearing P2MP emergency service messages.

Personal cellular telecommunications devices each require an Emergency Notification Service (ENS) client application which is preferably customized to reflect their individual technical specifications in terms of screen size, WAP capabilities, and the like. The ENS client application can be provided as a native application, Symbian application, J2ME application and the like, or as a SIM toolkit client application residing on a SIM card. Provision of ENS client application as a SIM toolkit enables an installed base of personal cellular telecommunications devices to be provisioned to receive the proposed CENS. Such customization is preferably effected in accordance with the teachings of commonly assigned PCT/IL2002/000127 published under PCT International Publication No. WO02/067538 entitled “Internet Session Initiation on Personal Cellular Telecommunications Devices, and Customization Protocol Therefor”. Text messages are preferably displayed on personal cellular telecommunications device in at least a network operator's native language and English such that the vast majority if not all users can read and understand same. Moreover, text messages can be displayed in all supported operating languages to ensure that all users without exception can read the text messages in their selected operating languages. P2MP emergency service messages in different languages can be broadcast on different P2MP emergency channels or on the same P2MP emergency channel in which case a language identifier is required for enabling a personal cellular telecommunications device to determine the correct P2MP emergency service message to be rendered. P2MP emergency messages broadcast on the same P2MP emergency channel can be broadcast in different languages either in different messages or concatenated into a single P2MP emergency service message.

The cellular emergency notification service may broadcast interactive P2MP emergency service messages in a similar manner to commonly assigned U.S. Pat. No. 7,039,423 B2 to Daniel et al., the contents of which are incorporated herein by reference. Interactive P2MP emergency service messages may require a user to acknowledge receipt of same to validate reception before his personal cellular telecommunications device reverts to normal operation, thereby providing information regarding the number of users in the different affected cells. Depending on the nature of an emergency regarding which users are being notified, interactive P2MP emergency service messages may include one or more queries. For example, P2MP emergency service messages may request volunteer blood donors, and, in the affirmative, the users may then be further requested to provide personal details, for example, their age, weight, blood type, and the like.

### BRIEF DESCRIPTION OF THE DRAWINGS

In order to understand the invention and to see how it can be carried out in practice, preferred embodiments will now be described, by way of non-limiting examples only, with reference to the accompanying drawings in which similar parts are likewise numbered, and in which:

FIG. 1A is a schematic diagram of a GSM cellular telecommunications network for broadcasting a cellular emergency notification service to GSM personal cellular telecommunications devices;

FIG. 1B is a schematic diagram of a GSM personal cellular telecommunications device for automatic immediate rendering of P2MP emergency service messages;

FIG. 2 is a schematic representation of a CBDD emergency service message for displaying the text “Stay away from city center” in English on a GSM device set to English as its operating language;

FIG. 3 is a schematic representation of CBDD emergency service message for displaying the text “Stay away from city center” in Hebrew on a GSM device set to Hebrew as its operating language;

FIG. 4 is a schematic representation of a CBDD emergency service message for displaying the text “Stay away from city center” in English and Hebrew on GSM devices set to English and Hebrew as their operating languages;

FIG. 5 is a schematic representation of an English language CBDD interactive emergency service message for displaying the text “Stay away from city center” and requesting volunteer blood donors; and

FIG. 6 is a flow diagram of the set up and operation of the cellular emergency notification service.

### DETAILED DESCRIPTION OF PREFERRED EMBODIMENTS OF THE PRESENT INVENTION

The present invention is described in connection with Global System for Mobile Communication (GSM) mobile service. In this regard, reference is made to the following Technical Specifications and publications, the contents of which are incorporated herein by reference:

GSM 03.41/3GPP 23.041 3^{rd} Generation Partnership Project; Technical Specification Group Terminals; Technical realization of Cell Broadcast Service. Section 9.4.1.2.2 specifies ranges of Message Identifiers (MI) for different usage and applications. Some ranges are deliberately left for discretionary use by a network operator, for example, A000-AFFF (hex) is a network operator specific range. The type of information provided by network operators using these Message Identifiers is not guaranteed to be the same across different network operators. The range 1000-10FF (hex) is specified for Cell Broadcast Data Download (CBDD).

GSM 11.14 Digital cellular telecommunications system (Phase 2+); Specification of the SIM Application Toolkit for the Subscriber Identity Module—Mobile equipment (SIM-ME) interface. Section 7.2 specifies a SIM includes an Elementary File EF_{CBMID} which lists Cell Broadcast channels for STK applications. This Technical Specification lists which EFs are accessible from a mobile handset Human Machine Interface. EF_{CBMID} is not one of the listed EFs as opposed to, say, EF_{CBMI} which lists Message Identifiers specifying the type of content of the cell broadcast messages that users wish his MS to accept.

GSM 3.38/3GPP 23.038 3^{rd} Generation Partnership Project; Technical Specification Group Terminals; Alphabets and language-specific information. Section 5 specifies a Data Coding Scheme (DCS) parameter for indicating a cell broadcast message is of the Data Download (DD) type for transparent passing from a Mobile Equipment (ME) to a SIM for handling by a client application residing thereon.

CBF-PUB(02)2R2.1—Cell Broadcast Forum, Handset Requirements Specification entitled “Reaching Millions in a Matter of Seconds”. Section 4.1.1.8 SIM data download reads as follows: The MS shall be capable of receiving CB messages in the range of MI 1000 (hex)—10FF (hex) automatically (SIM Data Download). This mode of operation is controlled by the Elementary File CBMID (EF_{CBMID}) on SIM card. As soon as there is an activated CMBID field on SIM and there are one or more Message Identifiers stored in this field, the MS shall scan the Cell Broadcast channel (CBCH) for CB messages with that Message Identifier and receive them. Received SIM Data Download messages are to be passed directly to the SIM card.

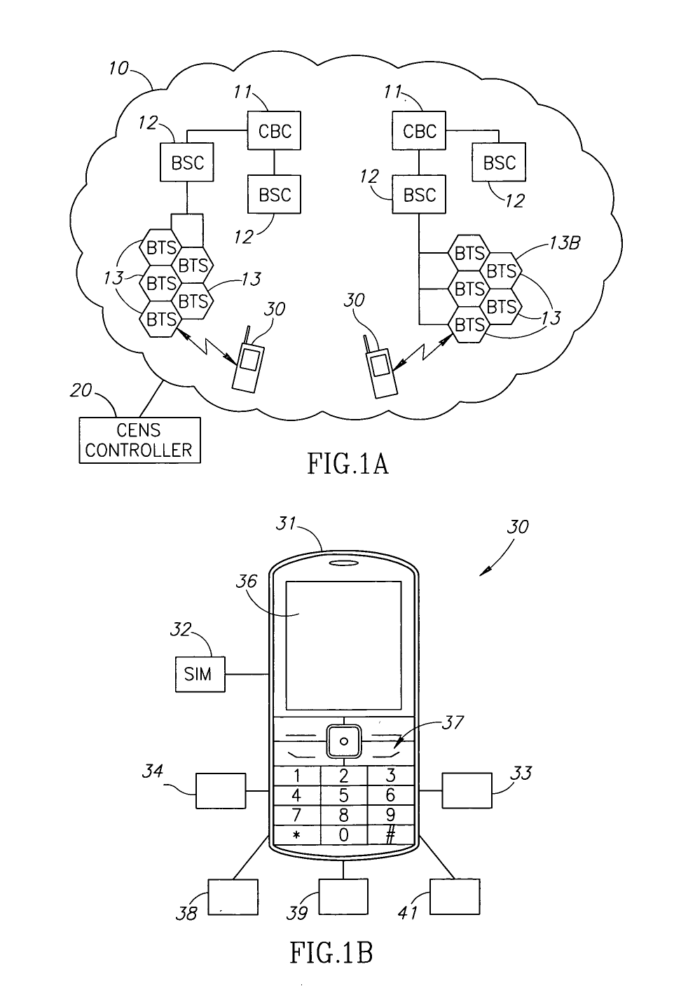

FIG. 1A show a GSM cellular telecommunications network 10 (hereinafter “GSM network”) including a plurality of Cell Broadcast Controllers (CBCs) 11, a plurality of Base Station Controllers (BSCs) 12, and a plurality of individually addressable Base Transceiver Stations (BTSs) 13 each providing bidirectional signal coverage to personal cellular telecommunications devices (hereinafter abbreviated to “devices”) 30 over predefined geographical areas ranging from so-called indoor pico cells each covering a few square meters through so-called micro cells each covering anywhere from a few tens of to a few hundreds of square meters upto cells covering several square kilometers. CBC vendors include inter alia Celltick Technologies Ltd., Herzliya, Israel (see www.celltick.com). The GSM network 10 is in communication with a Cellular Emergency Notification Service (CENS) Controller 20 for transmitting P2MP emergency service messages on one or more P2MP emergency channels to the devices 30 in one or more affected cells. The devices 30 include inter alia simple handset phones, smartphones, combined PDA/phones, combined MP3 music players/phones, and the like. P2MP emergency channels are preferably Cell Broadcast channels dedicated for SIM Data Download in the range of MI 1000(hex)—10FF(hex) but other ranges can also be used. In the present case, the GSM network 10 is broadcasting P2MP emergency service messages on a single #1004 (hex) logical P2MP transmission channel constituting the P2MP emergency channel.

FIG. 1B shows GSM devices 30 include a host Mobile Equipment (ME) 31, and a resident Subscriber Identity Module (SIM) card 32 capable of holding one or more Elementary Files and running SIM toolkit client applications. The host ME 31 has its own unique vendor allocated 15 digit International Mobile Equipment Identification (IMEI) number, for example, 490548400308362. The SIM card 32 has a cellular operated allocated 15 digit International Mobile Subscriber Identity (IMSI) number, for example, 425010100437187, and is capable of storing SIM toolkit client applications. The device 30 include a cellular network interface 33 for bidirectional interfacing with the cellular telecommunications network 10 and receiving P2MP messages, an operating system 34 in communication with the cellular network interface 33, a display screen 36, a user interface 37 for inputting instructions, and a memory unit 38. GSM devices 30 include a Man Machine Interface (MMI) 39 for enabling inter alia activating and de-activating user configurable cell broadcast channels as determined by their listing in the SIM's Elementary Files.

The GSM devices 30 are each provided with an Emergency Notification Service (ENS) client application 41 for automatic immediate rendering of P2MP emergency service messages. The ENS client application 41 is preferably provided in the form of a SIM Toolkit (STK) client application so as to be executable on all GSM devices in a uniform manner. Alternatively, the ENS client application can be provided as a Symbian application, or an embedded application. The P2MP emergency service messages are of the Cell Broadcast Data Download (CBDD) type for transparent passing to GSM devices' SIMs 32 for handling by their STK ENS client applications 41.

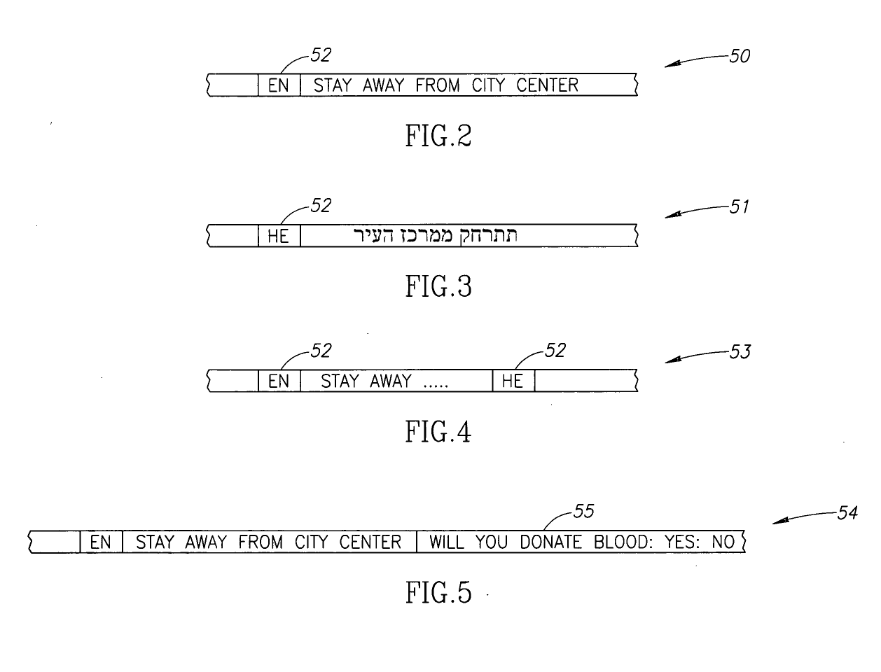

FIGS. 2 to 5 show schematic representations of different embodiments of P2MP emergency service messages for transparent passing to ENS client applications 41. FIGS. 2 and 3 show P2MP emergency service messages 50 and 51 for displaying the same text “Stay away from city center” in English and Hebrew, respectively. The P2MP emergency service messages necessarily require a Language Identifier field 52 to enable an ENS client application to discriminate between different language texts being broadcast on the same emergency channel #1004 (hex). FIG. 4 shows a single P2MP emergency service message 53 concatenated with the same texts as the emergency messages each having a preceding language identifier field. FIG. 5 shows an interactive P2MP emergency service message 54 for displaying the text “Stay away from city center” in English and an interactive field 55 requesting volunteer blood donors. User depression of the OK pushbutton to confirm that a user is prepared to donate blood typically initiates a Point-To-Point session.

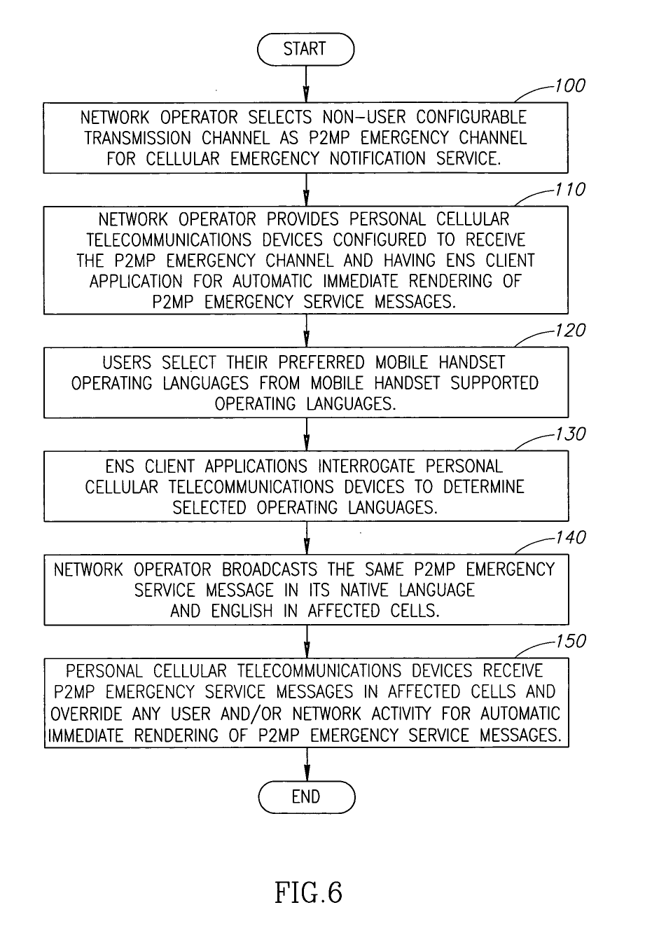

FIG. 6 shows four set-up steps as follows:

Step 100 shows network operator selection of a non-user configurable transmission channel as a P2MP emergency channel for a cellular emergency notification service. Step 110 shows network operator provision of personal cellular telecommunications devices configured to receive the P2MP emergency channel and having an ENS client application. In the GSM network 10, this can be conveniently implemented by distribution of SIM cards preconfigured with their EF_{CBMID} listing, say, Cell Broadcast channel #1004 (hex) selected as a single P2MP emergency channel, and a STK ENS client application for automatic immediate rendering of P2MP emergency service messages in a uniform manner.

Step 120 shows user selection of a mobile handset supported operating language. Step 130 shows ENS client application interrogation of mobile handset to determine its user selected operating language for subsequent rendering of P2MP emergency service messages in the correct language.

FIG. 6 shows two operation steps as follows:

Step 140 shows broadcasting the same P2MP emergency service message in at least the network operator's native language and English in at least one affected cell. Step 150 shows personal cellular telecommunications devices receiving P2MP emergency service messages in affected cells and overriding any user and/or network activity for automatic immediate rendering of the P2MP emergency service messages.

While the invention has been described with respect to a limited number of embodiments, it will be appreciated that many variations, modifications, and other applications of the invention can be made within the scope of the appended claims.

We claim:

1. Cellular emergency notification service comprising the steps of:
(a) providing personal cellular telecommunications devices capable of receiving P2MP messages on at least one logical P2MP transmission channel and having a Man Machine Interface (MMI) for user configuration of some but not all of the at least one logical P2MP transmission channel and having an Emergency Notification Service (ENS) client application for immediate automatic rendering of P2MP emergency service messages;
(b) configuring the personal cellular telecommunications devices to receive at least one logical P2MP transmission channel of the non-user configurable at least one logical P2MP transmission channel for use as at least one mandatory P2MP emergency channel; and
(c) transmitting P2MP emergency service messages on the at least one mandatory P2MP emergency channel for mandatory automatic immediate rendering on the personal cellular telecommunications devices.

2. The service as claimed in claim 1 wherein the personal cellular telecommunications devices support a multiplicity of operating languages including at least a network's operator's native language and English and step (c) includes transmitting P2MP emergency service messages in the multiplicity of operating languages whereupon the ENS client application determines a user selected operating language for displaying text messages in same.

3. The service as claimed in claim 2 wherein at least some of the P2MP emergency service messages are interactive P2MP emergency service messages having an integrally formed Point-To-Point (P2P) transmission mechanism for initiating a P2P session.

4. The service as claimed in claim 3 wherein a cellular user is required to acknowledge receipt of an interactive display message prior to his personal cellular telecommunications device reverting to normal operation.

5. The service as claimed in claim 4 wherein the at least one mandatory P2MP emergency channel is listed in a GSM SIM's Elementary File EF_{CBMID} and the SIM includes a SIM toolkit ENS client application.

6. The service as claimed in claim 3 wherein the at least one mandatory P2MP emergency channel is listed in a GSM SIM's Elementary File EF_{CBMID} and the SIM includes a SIM toolkit ENS client application.

7. The service as claimed in claim 2 wherein the at least one mandatory P2MP emergency channel is listed in a GSM SIM's Elementary File EF_{CBMID} and the SIM includes a SIM toolkit ENS client application.

8. The service as claimed in claim 1 wherein at least some of the P2MP emergency service messages are interactive P2MP emergency service messages having an integrally formed Point-To-Point (P2P) transmission mechanism for initiating a P2P session.

9. The service as claimed in claim 8 wherein a cellular user is required to acknowledge receipt of an interactive display message prior to his personal cellular telecommunications device reverting to normal operation.

10. Cellular telecommunications network for transmitting P2MP emergency service messages of the cellular emergency notification service as claimed in claim 1.

11. Personal cellular telecommunications device for rendering P2MP emergency service messages of the cellular emergency notification service as claimed in claim 1.
